(19) United States
(12) Patent Application Publication
(10) Pub. No.: US 2026/0064845 A1
(43) Pub. Date: Mar. 5, 2026

(54) COMPUTER DATA STORAGE DEVICE WITH DATA RECOVERY FUNCTION AND CONTROL METHOD THEREOF

(71) Applicant: Deok Woo KIM, Seoul (KR)

(72) Inventor: Deok Woo KIM, Seoul (KR)

(21) Appl. No.: 18/857,935

(22) PCT Filed: Feb. 15, 2023
(86) PCT No.: PCT/KR2023/002197

§ 371 Date: Jul. 15, 2025

(30) Foreign Application Priority Data
Apr. 21, 2022 (KR) 10-2022-0049514

(51) Int. Cl. G06F 21/56; G06F 11/14; G06F 21/53

(52) U.S. Cl. CPC G06F 21/568; G06F 11/1458; G06F 21/53

(57) ABSTRACT

A computer data storage device connected to a host computer through a host interface is disclosed. The computer data storage device contains a storage unit which stores data and includes a user area and a security area; a user input/output unit which receives an input relating to an operation mode of the computer data storage device, that is, a normal mode and a management mode, and related information from a user and displays same; and a control unit which communicates with the host computer and is connected to the storage unit and the user input/output device so as to control the operation mode. The control unit is configured to, when the host computer is to change structure information of the user area, generate recovery information for preserving data stored in the user area and store same in the security area.

### TECHNICAL FIELD

The present invention relates to a data storage device and a file system management technology of a computer, and more specifically, to a file system management technology capable of recovering damage to a file system without the need for a user to switch a computer to a recovery mode in response to the user noticing the damage to the file system when using a data storage device having a storage space divided into a user area and a security area.

### BACKGROUND ART

Generally, data storage devices such as a solid-state drive (SSD) and a hard disk drive (HDD) attached to a computer are recognized as a passive device from the perspective of a computer, and perform operations of accessing designated sectors or clusters according to a command transmitted from the computer. However, the applicant has filed inventions related to a data storage device that provides the existing data storage device with active functions such that a file system of a computer may be recovered when damaged by ransomware or virus attacks (WO 2018/208032, WO 2018/212474, and WO 2019/00951). The inventions of these previous applications deal with an auxiliary storage device including an original auxiliary storage device and a backup auxiliary storage device. The original auxiliary storage device is always accessible to the host computer, but the backup auxiliary storage device is restricted to allow access to the user only under certain conditions (e.g., a recovery mode). Therefore, safe backup and recovery are possible using the inventions of the previous applications.

In particular, among the inventions of the previous applications, an auxiliary storage device in WO 2018/212474 includes a separate central processing unit (CPU) and a storage medium unit that protect and monitor a file system, independent of the connected host computer. Here, the storage medium unit includes a user area in which an operating system (OS) of the host computer is stored and writing and reading by the computer is allowed, and a recovery area in which a copy of the OS of the host computer is optionally stored and writing and reading by the host computer are determined according to a mode (a normal mode or a recovery mode) selected by a mode selection switch.

If the normal mode is selected by the mode selection switch, a host computer's access to the recovery area is completely blocked. In addition, if the recovery mode is selected by the mode selection switch, and the host computer requests the OS of the user area during boot, the copy of the OS stored in the recovery area may be optionally provided to the host computer. In addition, in the normal mode, if the host computer changes content of a file or cluster in the user area, information required for recovery of the existing file or cluster is stored in the recovery area, and the changed file is stored in the user area. In the recovery mode, the user recovers the changed file system using the information required for recovery stored in the recovery area.

### DISCLOSURE

### Technical Problem

In the inventor's previous applications, recovery of a file system requires switching the operation mode to the recovery mode, which makes the configuration and procedure complicated. Therefore, if restoration from file system damage were possible without changing to a recovery mode, users would be able to respond rapidly, which would be considered highly significant.

Therefore, the inventor aims to propose a computer data storage device that allows damaged data or files to be recovered without a separate mode switch.

### Technical Solution

In the previous applications described above, information for recovery is stored in a recovery area, inaccessible to the host computer OS, located in the storage medium unit, and the information in the recovery area is used to perform recovery, in which both the recovery task and the deletion of recovery area data are allowed only in a recovery mode. The reason for allowing the recovery task and the deletion of recovery area data only in the recovery mode is that when the recovery area is exposed in an environment other than the recovery mode, there is a possibility that the recovery area may be damaged. Meanwhile, entering the recovery mode requires a time-consuming procedure, such as rebooting the host computer or checking whether the host computer is infected.

Although this is a safe method, it is inconvenient as it takes much time. In order to resolve the issue, providing a method in which information in a recovery area is read and used for a recovery task even in a normal mode may enable changes in the file system to be checked and recovery to be performed in a simple manner, offering significant benefits.

According to the previous applications described above, in a normal mode, the file system of the host computer includes only the user area, and the recovery area is not included in the file system of the host computer and is thus not accessible. This issue needs to be resolved to implement the method according to the present invention. To this end, the computer data storage device according to the present invention has the recovery area of the inventions of the previous applications or a security area different from the recovery area of the inventions of the previous applications.

That is, the computer data storage device according to the present invention includes a storage unit having a user area and a security area and operates in a normal mode and a management mode. The user area allows the host computer to always change the structure, or configuration, of the file system, including the attributes of file system objects, such as partitions, folders, and files. The security area stores recovery information generated by the computer data storage device according to the present invention for recovery of the user area. The recovery information is, in the normal mode, included and displayed in the file system of the user area but not changed or deleted and only read by the host computer, and to be changed and deleted by the host computer only in the management mode.

Unlike a recovery area of the inventions of the previous applications, the security area of the present invention is, in a normal mode, displayed in the file system of the host computer, and writing, deletion, and attribute changes are not allowed while reading is allowed. Therefore, when the file system is damaged, a recovery program may rapidly perform a recovery task on the file system using the recovery information provided through the security area. If the recovery program is being stored in the security area, the recovery program could be even more secure from malicious code attacks. The host computer's attempts to change the attributes of the security area, delete, or write in the normal mode are rejected by the computer data storage device.

The security area may be generated by setting a part of the space of the data storage device as a security area during manufacturing, or by a user setting a part of the user area as a security area in a management mode. Alternatively, in the case of having a recovery area disclosed in the inventions of the previous applications, the security area may be generated by designating a part of the recovery area as a security area that may be displayed and used in a management mode. In this case, the data storage device may have the recovery mode (see the inventions of the previous applications) and the management mode at the same time.

Meanwhile, the computer data storage device according to the present invention is configured to, when the host computer attempts to delete or change content of the storage device, generate recovery information for recovering the content of the storage device and store the recovery information in the security area. Since the recovery information is basically generated every time the relevant sector or cluster is changed, recovery is performed even when ransomware or a hacker deletes and encrypts a user's files. Since the recovery information includes all changes to the file system, the user may restore the file system to a desired point in time in any case.

In addition, the computer data storage device according to the present invention has a function of, when the host computer deletes structure or configuration information (e.g., a master file table (MFT), a file allocation table (FAT), etc.) to delete a file or folder in the user area, analyzing the structure information and generating a file or folder according to the structure information in the security area. For example, when the host computer deletes a specific file “spring.docx” in the user area, clusters constituting “spring.docx” are released from the occupied state based on structure information of the file being deleted. However, the storage device according to according to the present invention may generate a backup file referred to as “spring_backup202204051230001.docx” in the security area by referring to the structure information before releasing the occupied state, thereby providing recovery information that may be immediately used. Therefore, the user may rapidly and easily recover spring.docx by reading spring_backup202204051230001.docx without needing to switch to the management mode when a problem occurs.

Meanwhile, if ransomware that has taken control of the host computer deletes the file Spring.docx, the ransomware may read the structure information of the file, identify the storage location of the file data in the structure information, and then attempt to directly overwrite the corresponding cluster. In this case, the storage device according to the present invention generates content of the corresponding cluster and other information required for the recovery in a file format and generates the generated file in a security area, thereby providing the user with information for recovery.

When the mode of the computer data storage device is switched to a management mode, the host computer (actually, the OS and an application program) may freely use the security area in that state, which allows deletion of the recovery information, so caution is required. In general, most OSs, including Windows, allows file system objects, such as folders or files, to be read-only by changing the attributes thereof, but since this is ultimately controlled by the OS, malware such as ransomware may perform deletion or encryption by changing the attributes, which is still unsafe.

An example of a method of generating a security area is for the user to generate a partition or folder with a pre-determined name in a management mode to generate a security area. For example, assuming that the manufacturer of the data storage device according to the present invention has designed a partition or folder generated with the name “RECOVERY” to be recognized as a security area, a user may generate a security area by generating a partition or folder named “RECOVERY.” Then, the data storage device according to the present invention generates recovery information when the file system is changed and stores the recovery information in the partition or folder named RECOVERY, which is a security area.

In addition, the user may set the size of the security area and set a recovery information management method in a management mode. As an example of the recovery information management method, it may be set to notify the user when the recovery information accumulates in the security area and there is no free space, and to request management of the security area. As another example of the recovery information management method, it may be set to delete the stored recovery information after a certain period of time without setting a limit on the size of the security area to manage the security area.

Meanwhile, the generation and management procedure of the security area may be performed by a user executing a management program. For example, when a user purchases the computer data storage device according to the present invention and runs a management program on a host computer, the user is guided to switch a usage mode to a management mode, and when the user switches to the management mode and inputs the location, name, size, etc. of a security area, the security area is generated. In this case, a recovery program may be stored in the security area. Afterward, when the user switches the operation mode to a normal mode, the computer data storage device generates recovery information whenever the structure of the user area is changed and stores the recovery information in the security area. As described above, the attributes and content of the security area may not be changed by the host computer and may only be read in the normal mode and may be changed and deleted by the host computer only in the management mode.

According to an aspect of the present invention, there is provided a computer data storage device, which includes: a host interface that communicates with a host computer; a storage unit that stores data separately in a user area and a security area; a user input/output unit that receives input regarding an operation mode of the computer data storage device, that is, a normal mode and a management mode, and related information thereof, from a user and displays the input and the related information; and a control unit that is connected to the host interface, the storage unit, and the user input/output unit to control the operation mode;

The user area allows the host computer to freely change the structure, including attributes of file system objects such as partitions, folders, and files at all times;

The security area of the storage unit stores recovery information for recovery of the user area generated by the computer data storage device 10, and the security area is, in a normal mode, included and displayed in the file system of the user area, but is not allowed to be changed or deleted and is only read by the host computer, and only in a management mode, is allowed to be changed and deleted by the host computer.

In this case, the operation mode of the computer data storage device may be determined by a data value transmitted through communication of the host computer and the host interface, in addition to a method using the user input/output unit, and the operation status may be displayed through the user input/output unit.

In this case, the recovery information may be a file or folder generated in the security area based on analysis of structure information by the computer data storage device according to the present invention, in response to the structure information being deleted by the host computer to delete a file or folder of the user area.

The above described detailed features of the present invention and other features may become apparent through specific embodiments described below together with the accompanying drawings.

### Advantageous Effects

The data storage device according to the present invention is configured to, when the host computer attempts to delete or change stored content, generate recovery information and store the recovery information in the security area. In this case, since the recovery information is generated every time the relevant sector or cluster is changed, recovery of the file system can be performed even when ransomware or a hacker deletes and encrypts a user's files. In addition, since the recovery information includes all changes to the file system, the user can restore the file system to a desired point in time in any case. In addition, unlike the inventions of the previous applications in which recovery information stored in the recovery area is read only in the recovery mode, the computer storage device according to the present invention can allow recovery information stored in the security area to be read even in the normal mode. Therefore, the user can rapidly recover the damaged file system without switching to the recovery mode. The ability to view the recovery information in a normal mode is a great advantage, and thus the user can immediately recover the damaged file system with the recovery information.

In addition, when the host computer deletes structure information of a file or folder in the user area, the structure information is analyzed and the file or folder is generated according to the structure information and moved to the security area, and thus the user can rapidly recover the file or folder when a problem occurs.

### DESCRIPTION OF DRAWINGS

FIG. 1 is a block diagram illustrating a computer data storage device according to an embodiment.

FIG. 2 is a procedure diagram showing a method of generating a security area.

FIG. 3 is a procedure diagram showing another method of generating a security area.

FIGS. 4A to 4E are exemplary diagrams of a file system, for describing operations in a normal mode and a recovery procedure.

### MODES OF THE INVENTION

Hereinafter, exemplary embodiments of the present invention will be described in detail with reference to the attached drawings. Terms used herein are used to aid in the description and understanding of the embodiments and are not intended to limit the scope and spirit of the present invention. As used herein, the singular forms “a” and “an” are intended to include the plural forms as well, unless the context clearly indicates otherwise. Also, as used herein, the terms “comprise,” “comprising,” “include,” and/or “including” specify the presence of listed features, elements, steps, operations, components, and/or parts, but do not preclude the presence or addition of one or more other features, elements, steps, operations, components, parts, and/or groups.

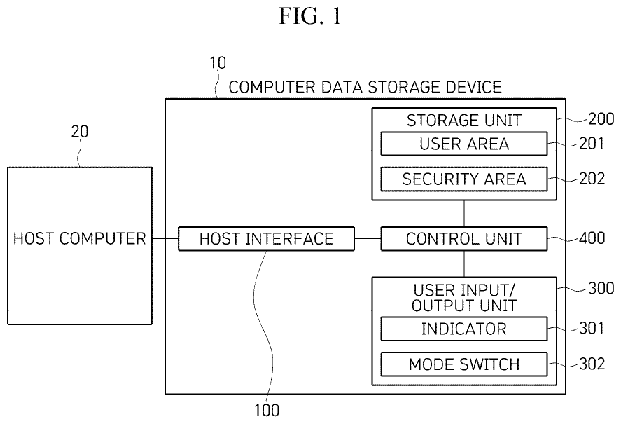

Referring to FIG. 1, a computer data storage device 10 according to an embodiment according to the present invention includes a host interface 100 for communicating with a host computer 20, a storage unit 200 having an area divided into a user area 201 and a security area 202, a user input/output unit 300 that receives input regarding an operation mode of the data storage device 10, that is, a normal mode and a management mode, and related information, from a user and displays the input and the related information, and a control unit 400 that is connected to the host interface 100, the storage unit 200, and the user input/output unit 300 and controls the operation mode of the computer data storage device 10. In this case, although somewhat dangerous, input regarding the normal mode and the management mode may also be received through the host interface 100. Meanwhile, the user input/output unit 300 includes an indicator 301, such as a light emitting diode (LED), for displaying the operation mode and a mode switch 302 for selecting the operation mode. The state of the indicator 301 is, for example, green in the normal mode and red in the management mode.

The computer data storage device 10 according to the present invention operates in a normal mode and a management mode with the storage unit 200 having the user area 201 and the security area 202. The user area 201 allows the host computer to freely change the structure of the file system, including attributes of file system objects such as partitions, folders, and files at all times, and the security area 202 stores recovery information for recovery of the user area 201 generated by the computer data storage device 10. The security area 202 and content thereof are, in a normal mode, included and displayed in the file system of the user area 201, but are not allowed to be changed or deleted and are only read by the host computer, and are allowed to be changed and deleted by the host computer only in a management mode.

That is, unlike the recovery area of the previous applications, in a normal mode, the security area 202 is displayed in the file system of the computer, and writing, deleting, and attribute changing are not allowed while reading is allowed. Therefore, when the file system is damaged, a recovery program may rapidly perform the recovery task on the file system using the recovery information provided by the security area 202. When the recovery program is stored in the security area 202, the recovery program may be even more secure from malicious code attacks. Attempts to change the attributes of the security area 202, delete, or write in a normal mode are rejected by the computer data storage device 10.

Hereinafter, a method of generating the security area 202 will be described. The security area 202 may be generated in various methods, and in one embodiment, the security area 202 may be generated by executing a management program on the host computer 20.

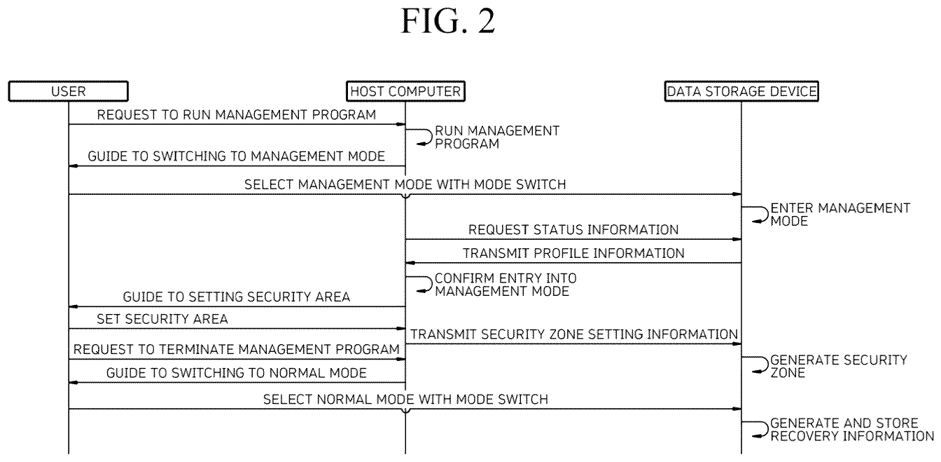

In one embodiment, referring to FIG. 2, the user connects the computer data storage device 10 according to the present invention to the host computer 20 and then executes a management program provided together on the host computer. The management program of the host computer 20, when executed, guides the user to use the mode switch 302 or enter a password such that the password is transmitted through the host interface 100 to change the mode of the computer data storage device 10 to the management mode.

When the user selects the management mode using the mode switch 302 of the user input/output unit 300, a signal for changing to the management mode is input to the control unit 400 of the data storage device 10, and the control unit 400 receives the signal, switches the mode to the management mode, and changes the indicator 301 of the user input/output unit 300 to red. The management program of the host computer 20 receives the change to the management mode through the computer data storage device 10 and the host interface 100.

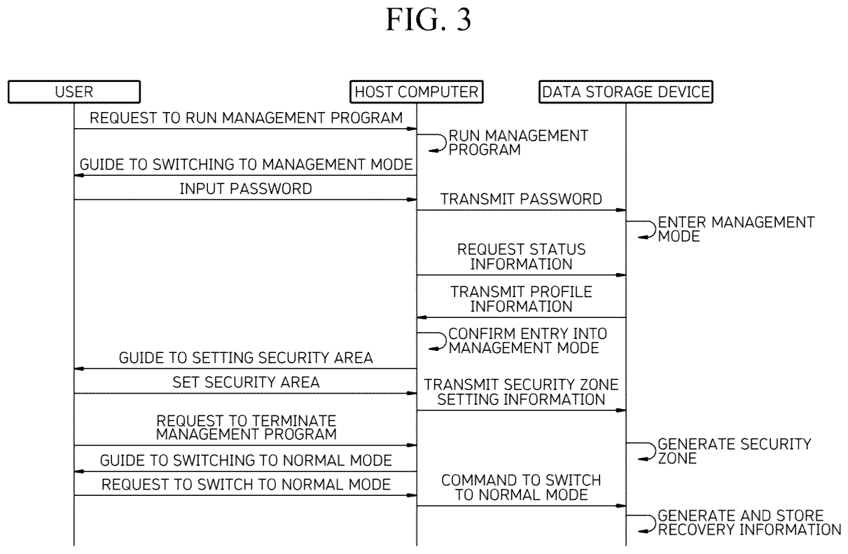

In another embodiment, referring to FIG. 3, when the user enters a password based on the fact that the management program has guided the user to use the mode switch 302 or enter a password to switch the mode of the computer data storage device 10 to the management mode, the management program of the host computer 20 may transmit the password to the control unit 400 of the data storage device 10 through the host interface 100, and the control unit 400 may compare the password with a preset password and allow entry into the management mode. Setting and managing the password may be easily implemented according to a procedure commonly seen in general computer devices. However, while it is easy to confirm entry into the management mode using a password, caution is needed as it may become an attack route for malicious code.

Next, referring to FIGS. 2 and 3, when the management program of the host computer 20 requests status information of the computer data storage device 10 through the host interface 100 and waits, the computer data storage device 10 provides profile information including a manufacturing number, a system software version, and a current operation mode thereof, information of the user area 201, and information of the security area 202. The management program receives the information and confirms that the computer data storage device has entered the management mode.

Before switching to the management mode, the user needs to check for malicious code. Because malicious code may read the information of the computer data storage device 10 or change or delete the content of the security area 202, caution is required.

Next, in the management mode, the management program of the host computer 20 guides the user to set attributes of the security area 202 and the like. For example, the user is guided to set the name for a security area 202. In one embodiment, assuming that the security area 202 is set in the top folder of the primary partition, the user may name the security area 202 MY_RECOVERY_DATA. In addition, the user may set the size of the security area 202 and the recovery information management method. For example, the size of the security area 202 may be set to 100 GB, and when the recovery information continues to accumulate in the security area 202 and there is no free space, the change to the structure of the user area 201 may be prohibited, and the user may be notified and requested to manage the security area 202. Here, a method of notifying the user and requesting management of the security area 202 may use the indicator 301. For example, the indicator 301 may be changed from green to green blinking to provide the guidance “There is no free space in the security area 202, please delete old recovery information using the management program.” As another example of setting the security area management method, the security area management method may be set to delete the recovery information that has passed a certain period of time when the amount of the recovery information stored in the security area 202 increases to a certain level or greater. For example, the user may set recovery information older than 48 hours to be deleted in order of the oldest information when the free space of the security area 202 drops to a level less than or equal to 5%. However, even in this case, it is desirable to manage the recovery information by the host computer 20 notifying the user and receiving confirmation to execute the deletion.

Security area setting information set by the user is transmitted from the host computer 20 to the computer data storage device 10 through the host interface 100. The computer data storage device 10 then generates a security area. In some cases, when a security area 202 is generated, a recovery program may be stored in the security area 202.

When the user completes the setting and attempts to terminate the management program, a termination command is transmitted to the host computer 20, and the management program guides the user to switch the operation mode to the normal mode accordingly. Based on the user switching to the normal mode using the mode switch 302 (FIG. 2) or through the management program (FIG. 3), the computer data storage device 10 performs a task of generating recovery information whenever the structure of the user area 201 changes and storing the recovery information in the security area 202 (e.g., the MY_RECOVERY_DATA folder). In the normal mode, the attributes and content of the security area may not be changed and may only be read by the host computer.

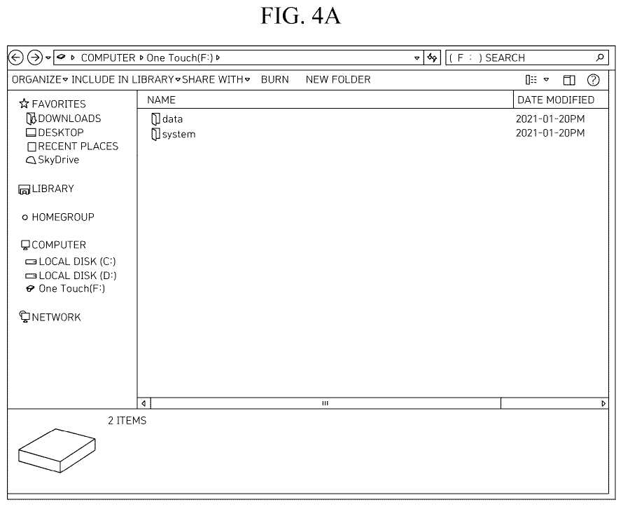

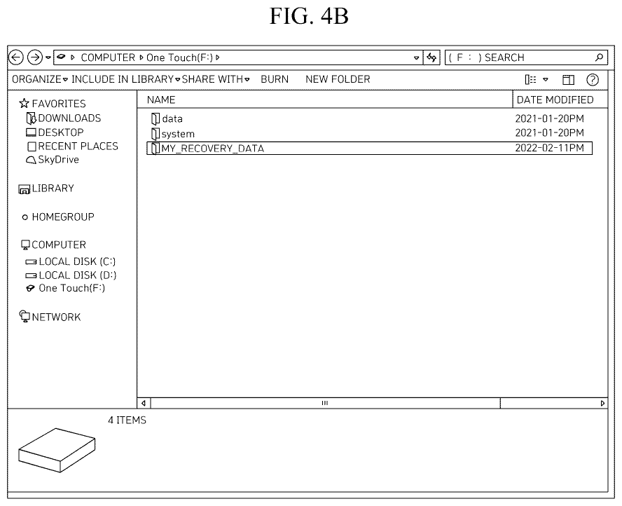

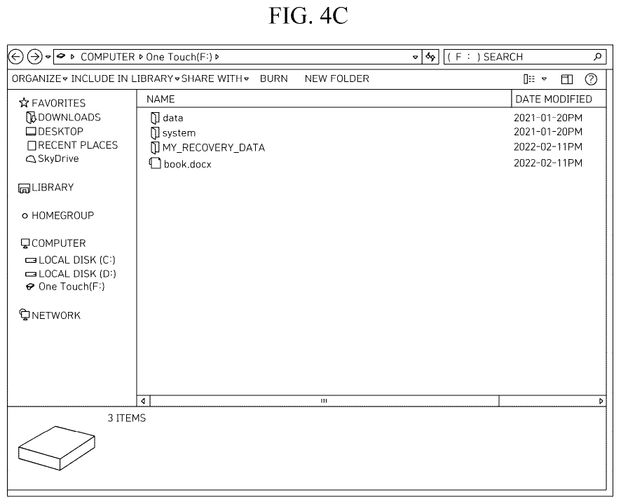

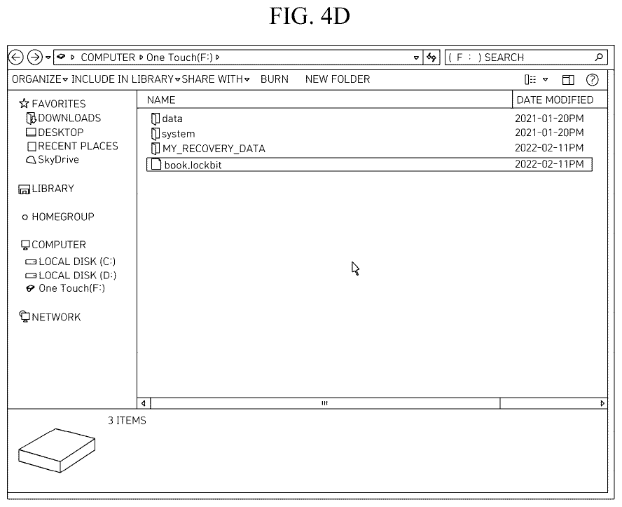

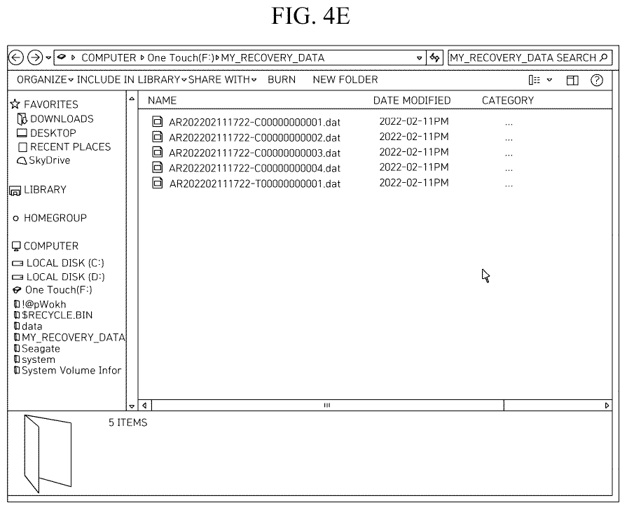

Hereinafter, the operations in the normal mode and the recovery procedure will be described with reference to examples in FIGS. 4A to 4E.

The user area 201 initially has a file system with two folders, that is, data and system, as shown in FIG. 4A. However, when the user generates a folder named MY_RECOVERY_DATA as a security area 202, the user area 201 has a file system that additionally includes the security area folder MY_RECOVERY_DATA, as shown in FIG. 4B. In this case, the folder MY_RECOVERY_DATA is empty.

Here, it may be assumed that the user generates a new document book.docx with MS-WORD and stores the new document in the top data folder. Then, the file system of the host computer is changed to a form that includes book.docx, as shown in FIG. 4C. In this case, it is assumed that book.docx is stored in clusters 01 to 04 of the storage unit 200 of the computer data storage device 10. Next, a case in which ransomware Lockbit invades, reads file information (e.g., an FAT or an MFT) of book.docx, generates an encrypted file book.lockbit, identifies that book.docx is stored in the clusters 01 to 04, and overwrites the corresponding clusters to delete structure (configuration) information will be considered. In this case, when the control unit 400 receives a request for an overwrite task, the control unit 400 generates access records containing content of the corresponding clusters 01 to 04 and related information before the task and stores the access records in the folder MY_RECOVERY_DATA, which is a security area. In this case, since content of clusters storing the structure information is changed, the content is also stored in the form of access records. Accordingly, the file system (e.g., an MFT, an FAT, etc.) is changed as shown in FIGS. 4D and 4E. It can be seen that, in FIG. 4D, book.docx is deleted and book.lockbit is generated, and in FIG. 4E, five access records are generated as recovery information in the folder MY_RECOVERY_DATA. In this case, the computer data storage device may use the access records in FIG. 4E, or may use the access records in FIG. 4E when the host computer deletes the structure information, to generate recovery information in the form of an immediately usable backup file, such as book_backup202204051230001.docx. Here, the recovery information may include not only the access records but also information about the connection between the access records (which objects are configured in the file system), and the like.

In the file names of the access records shown in FIG. 4E, the first part AR202202111722 indicates that an access record (AR) is generated at 17:22 on Feb. 11, 2022, and the last part indicates a serial number. Starting with C indicates content of the clusters 01 to 04 and related information thereof and starting with T indicates content of the cluster containing file system structure information, including an MFT, and related information thereof. Here, the related information may include information indicating the correlation of the clusters. That is, the related information may include information indicating that the clusters 01 to 04 form one file book.docx, for example, information indicating that these five access records form the file book.docx.

Even when the ransomware Lockbit attempts to delete the content of the folder MY_RECOVERY_DATA, since the content is located within the security area 202, in which changes to attributes and content are prohibited, the recovery information including the access records is safe. Also, when recovery information is continuously generated due to the ransomware Lockbit, and the set capacity of 100 GB is filled, the control unit 400 no longer responds to the host computer's request and requests confirmation from the user, thereby ensuring that the recovery information remains safely protected.

Now the recovery procedure will be described. When the user becomes aware of the infection with ransomware, the user runs a ransomware removal program to remove the ransomware and proceeds with the recovery procedure on the host computer 20. In this case, there is no need to switch to the management mode to proceed with the recovery procedure, and the user runs the recovery program in the normal mode. Since the information required for recovery is stored in the folder MY_RECOVERY_DATA, which is a security area, recovery may be performed simply. That is, in the case of the above example, book.docx is deleted by the ransomware in practice, but since the access records are held as the recovery information, the recovery of book.docx may be allowed later.

The embodiments that specifically implement the idea of the present invention have been described above. However, the technical scope of the present invention is not limited to the embodiments and drawings described above but is determined by a reasonable interpretation of the patent claims.

1. A computer data storage device that is connected to a host computer and stores data, the computer data storage device comprising:
a host interface that communicates with the host computer;
a storage unit that includes a user area and a security area;
a user input/output unit that receives input regarding an operation mode of the computer data storage device, that is, a normal mode and a management mode, and related information thereof from a user and displays the input and the related information; and
a control unit that is connected to the host interface, the storage unit, and the user input/output device to control the operation mode,
wherein the control unit is configured to, when the host computer attempts to change a structure of the user area, generate recovery information for preserving data stored in the user area and store the recovery information in the security area, and
the user area allows the host computer to freely change a structure of the user area, and
the security area, in a normal mode, precludes structure change by the host computer and allows reading, and in a management mode, allows structure change by the host computer.

2. The computer data storage device of claim 1, wherein a recovery program that performs a recovery task on a file system using the recovery information of the security area when the file system is damaged is stored in the security area.

3. The computer data storage device of claim 1, wherein the control unit is further provided with a function of, when the host computer deletes structure-related information to delete a file or folder of the user area, analyzing the structure-related information and generating the file or folder in the security area.

4. The computer data storage device of claim 1, wherein in the normal mode the security area is displayed as a part of the user area, and a request for a structure change from the host computer is rejected.

5. The computer data storage device of claim 1, wherein in the management mode a size of the security area and a recovery information management method stored in the security area are set.

6. The computer data storage device of claim 5, wherein the recovery information management method is configured to notify a user when the security area has no more free space due to accumulation of the recovery information.

7. The computer data storage device of claim 5, wherein the recovery information management method is configured to delete recovery information that has exceeded a preset period among the recovery information stored in the security area.

8. A method of controlling a computer data storage device including: a host interface that communicates with a host computer; a storage unit that includes a user area and a security area; and a user input/output unit that receives input regarding an operation mode, that is, a normal mode and a management mode, and related information thereof from a user and displays the input and the related information, the method comprising:
when the host computer attempts to change a structure of the user area, generating recovery information for preserving data stored in the user area and storing the recovery information in the security area; and
when the structure of the user area is changed, performing a recovery task on the user area using the recovery information in the security area,
wherein the user area allows the host computer to freely change a structure of the user area, and the security area, in a normal mode, precludes structure change by the host computer and allows reading, and in a management mode, allows structure change by the host computer.

9. The method of claim 8, further comprising, when the host computer deletes structure-related information to delete a file or folder of the user area, analyzing the structure-related information and generating the file or folder in the security area.

10. The method of claim 8, further comprising designating the security area as a part of the user area in the management mode.

11. The method of claim 8, further comprising generating, in the management mode, the security area as a partition or folder displayed in the user area.

12. The method of claim 8, further comprising setting, in the management mode, a size of the security area and a recovery information management method.

13. The method of claim 12, wherein the recovery information management method is configured to notify a user when the security area has no more free space due to accumulation of the recovery information.

14. The method of claim 12, wherein the recovery information management method is configured to delete recovery information that has exceeded a preset period among the recovery information stored in the security area.
